(19) United States
(12) Patent Application Publication
(10) Pub. No.: US 2019/0034389 A1
(43) Pub. Date: Jan. 31, 2019

(54) METHOD AND APPARATUS FOR GENERATING AMENDED MARKED-UP TEXT

(71) Applicant: WAAZON (HOLDINGS) LIMITED, Weeton Yorkshire (GB)

(72) Inventors: James MARTINEZ, Almeria (ES); Paris Val BAKER, Cornwall (GB)

(21) Appl. No.: 16/072,363

(22) PCT Filed: Jan. 26, 2017
(86) PCT No.: PCT/GB2017/050206

§ 371 Date: Jul. 24, 2018

(30) Foreign Application Priority Data
Jan. 29, 2016 (GB) 1601714.7

(51) Int. Cl. G06F 17/21; G06F 17/30; G06F 17/22

(52) U.S. Cl. CPC G06F 17/218; G06F 17/30896; G06F 3/04842; G06F 17/2247; G06F 17/212

(57) ABSTRACT

A method for generating computer readable marked-up text. The method comprises receiving computer readable marked-up text, identifying displayable text included in the computer readable marked-up text, identifying one or more textual elements included in the displayable text, and generating amended computer readable marked-up text including the displayable text and one or more indicators indicating the identified textual elements

### FIELD OF THE INVENTION

This invention relates to methods and apparatus for generating marked-up text, and the subsequent display of, and extraction of words from the amended marked-up text via user interaction with the displayed amended marked-up text.

### BACKGROUND OF THE INVENTION

Internet search engines and hyperlinks play an important role when navigating the World Wide Web (WWW) as they provide a user friendly approach to finding relevant information and navigating between or within webpages or other Internet resources. For example, if a user wishes to obtain information on a specific topic they may enter a word related to the topic into an Internet search engine which will then present them with results that correspond to the search term. Hyperlinks may play a similar role where a particular word or image on a webpage may be associated with a link which takes the user to a webpage or a different portion of the current webpage that may provide further information on the word or image.

However, both of these approaches require either user selection of search terms and manual insertion into a search engine or require pre-programming. For example, if a user is reading a webpage relating to the Solar System and they wish to find further information on the planet Saturn, they may highlight the word Saturn and then copy and paste it into a search engine. Alternatively, the word Saturn may be a hyperlink to webpage relating to Saturn. However, this hyperlink is required to be manually determined and coded into the webpage code prior to the webpage being made available. Consequently, the act of navigating between webpages and the performance of searches, or the provision of functionality for the navigation between webpages can become time consuming. Furthermore, in the case of certain media types that may be presented via webpages, multimedia presentation mechanisms, television sets, video streaming or various other platforms, it may not be possible to insert hyperlinks or allow a user to copy and paste text for searching.

### BRIEF SUMMARY OF THE DISCLOSURE

The following aspects and examples of the present invention enable displayable text of marked-up text to be identified and subsequently indicated, and words within the displayable text divided into textual elements. These textual elements may then be extracted from the displayable text and made the subject of a search via user selection. Textual elements therefore become directly searchable, thus enabling a user to easily and efficiently perform searches based on displayed text, whether it be text forming part of a webpage, subtitles, video commentary or comments and so forth, without the use of hyperlinks or copying and pasting of displayed text.

In accordance with a first aspect of the present invention, a method for generating marked-up text is provided, the method comprising receiving computer readable marked-up text, identifying displayable text included in the computer readable marked-up text, identifying one or more textual elements included in the displayable text, and generating amended computer readable marked-up text including the displayable text and one or more indicators indicating the identified textual elements.

In accordance with an example of the present invention, the displayable text comprises one or more words and a textual element is formed from one or more words, and one or more predetermined words are not permitted to form a textual element, and the identifying one or more textual elements includes dividing the words of the displayable text that are not one of the one or more predetermined words into the one or more textual elements according to one or more predetermined rules. By virtue of excluding certain words from forming textual elements, the probability of textual elements relating to words with comparatively little meaning such as certain prepositions for example is reduced and the likelihood that textual elements are terms a user wishes to search increased.

In accordance with an example of the present invention, the method further comprises displaying the displayable text of the amended computer readable marked-up text, receiving user input with respect to the displayed text, determining, based on the indicators, whether the user input is with respect to a textual element of the displayed text, and displaying, in response to receiving user input with respect to a textual element of the displayed text, an indication of the respective textual element. By virtue of this, the textual elements are indicated to a user, so that they may easily identify the textual elements available to be selected.

In accordance with an example of the present invention, generating the amended computer readable marked-up text includes inserting the indicators into the received computer readable marked-up text.

In accordance with an example of the present invention, the indicators include one or more predetermined tags.

In accordance with an example of the present invention, generating the amended computer readable marked-up text includes enclosing each identified textual element with a pair of the predetermined tags. By virtue of identifying textual elements with predetermined tags, the textual elements may be recognised when the displayable text is being rendered for display, thus not requiring manual identification of textual elements as is would be the case with hyperlinks or manual copying and pasting.

In accordance with an example of the present invention, the amended computer readable marked-up text includes display layout information and the displaying the amended computer readable marked-up text includes displaying the displayable text in accordance with the display layout information.

In accordance with an example of the present invention, the computer readable marked-up text is in the HyperText Markup Language, HTML.

In accordance with an example of the present invention, the amended computer readable marked-up text is in the HTML.

In accordance with an example of the present invention, the tags are non-standard HTML tags.

In accordance with an example of the present invention, the marked-up text is included in closed-caption information.

In accordance with an example of the present invention, in response to receiving user input with respect to a textual element of the displayed text, inputting the respective textual element into a search engine. By virtue of this, terms displayed via the use of marked-up text may be simply and easily input into a search engine via a single user interaction without the use of hyperlinks or manual copying and pasting.

In accordance with an example of the present invention, the marked-up text is included in an HTML file and the amended marked-up text is included in an amended HTML file, and one or more of the determining whether the user input is with respect to a textual element of the displayed text, the displaying an indication of the respective textual element, and the inputting the respective element into a search engine are performed by client-side executable code included in the amended HTML file.

In accordance with an example of the present invention, the client-side executable code is JavaScript.

In accordance with a second aspect of the present invention, a user device for displaying text of marked-up text is provided, the user device comprising a receiver configured to receive marked-up text, and a processor configured to identify displayable text included in received computer readable marked-up text, identify one or more textual elements included in the displayable text, and generate amended computer readable marked-up text including the displayable text and one or more indicators indicating the identified textual elements.

In accordance with an example of the present invention, the displayable text comprises one or more words and a textual element is formed from one or more words, and one or more predetermined words are not permitted to form a textual element, and wherein the identifying one or more textual elements includes dividing the words of the displayable text that are not one of the one or more predetermined words into the one or more textual elements according to one or more predetermined rules.

In accordance with an example of the present invention, the user device further comprises a display configured to display the displayable text of the amended computer readable marked-up text, and a user input interface configured to receive user input with respect to the displayed text, and wherein the processor is configured to control the display to display the displayable text, detect a user input received through the user interface, determine, based on the indicators, whether the received user input is with respect to a textual element of the displayed text, and, in response to receiving user input with respect to a textual element of the displayed text, control the display to display an indication of the respective textual element, and extract the words of the respective textual element.

In accordance with an example of the present invention, the processor is configured, in response to receiving user input with respect to a textual element of the displayed text, to input the words of the respective textual element into a search engine.

In accordance with a third aspect of the present invention, a server for providing marked-up text to a user is provided, the server comprising a receiver configured to receive marked-up text, a processor configured to identify displayable text included in received computer readable marked-up text, identify one or more textual elements included in the displayable text and generate amended computer readable marked-up text including the displayable text and one or more indicators indicating the identified textual elements, and a transmitter configured to transmit the amended computer readable marked-up text to the user device.

In accordance with a fourth aspect of the present invention, a computer program comprising instructions arranged, when executed, to implement a method and/or apparatus in accordance with any one of the above-described aspects and examples. A further aspect provides machine-readable storage storing such a program.

### BRIEF DESCRIPTION OF THE DRAWINGS

Embodiments of the present invention are further described hereinafter with reference to the accompanying drawings, in which:

FIG. 1 provides an illustration of a flow diagram of a text selection method in accordance with an example of the present invention;

FIG. 2 provides an illustration of text selection method in accordance with an example of the present invention;

FIG. 3 provides an illustration of a flow diagram of a method for generating amended computer readable marked-up text in accordance with an example of the present invention;

FIG. 4 provides an illustration of a flow diagram of a method for identifying textual elements of displayable text of marked-up text;

FIG. 5 provides an illustration of a flow diagram of text selection method in accordance with an example of the present invention;

FIG. 6 provides an illustration of a flow diagram of a method for generating amended computer readable marked-up text from a received webpage in accordance with an example of the present invention;

FIG. 7 provides an illustration of communications exchanges that may take place between a server and a user device when a method in accordance with an example of the present invention is performed;

FIG. 8 provides an illustration of communications exchanges that may take place between a server and a user device when a method in accordance with an example of the present invention is performed;

FIG. 9 provides a schematic illustration of a server in accordance with an example of the present invention; and

FIG. 10 provides a schematic illustration of a user device in accordance with an example of the present invention.

### DETAILED DESCRIPTION

In accordance with embodiments of the present invention, a text based processing technique is provided which enables text included in a variety of media sources to be extracted and to act as the input to Internet search engines or hyperlinks to Internet search results thus enabling text of various media sources to become directly searchable for example. This enables a user to quickly and easily extract text from media and thus search for terms included in text on webpages, video streams, social networks and the like. For example, in accordance with the present invention a webpage displayed to a user is processed in such a manner that words or sequences of words such as verbs, nouns, proper nouns adjectives etc. become directly searchable by simply selecting the words via the available user interface, such that upon selection of a word or term, the word or term is directly entered into an Internet search engine or a searching engine associated with the website provider and a search performed. A missing link between conventional Internet searching and hyperlinks is therefore provided which increases the ease with which a user may navigate the World Wide Web.

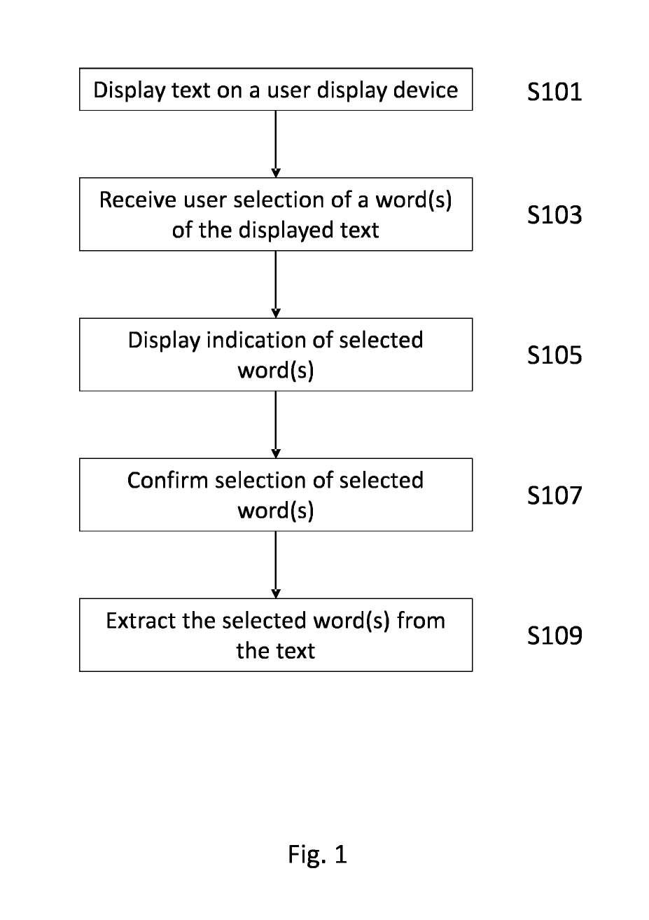

FIG. 1 provides a flow diagram which illustrates the functionality of embodiments of the present invention. At Step S101, text which has been processed in accordance one or more of the methods explained below is displayed to a user on a user display device, which may be a mobile telephone, tablet computer, a conventional computer or a television set for example. The text may be in any form but preferably is communicated to the user display device in the form of marked-up text such as that included in HTML webpages.

Once displayed, at Step S103 a user selects a word or a sequence of words which form a term or phrase, which may also be referred to as a textual element. For example, the user may select the term “Solar System” or “Saturn”. The user may perform the selection using any available user interface such as a touch screen interface, a mouse, a gesture based interface or a virtual reality interface for example. In the case of using a mouse, the selection may be performed by clicking on any of the words which form a textual element or simply by hovering or rolling-over the mouse cursor over a textual element.

At step S105, upon selection of a textual element by a user, the selected textual element may be indicated to the user via a visual indication. For example, upon selection of a textual element the word(s) forming the selected textual element may change colour, change font, be presented in bold, change size or vary in any other suitable manner such as the type of shape of cursor may change in response to selecting a textual element.

At Step S107, the user may confirm the selection of the selected textual element by performing a different user input to the one made in Step 103 or alternatively by maintaining the user input which was input in Step 103. For example the selection of step S103 may be performed by a mouse cursor being placed over a textual element whereas the confirmation of the selection may be performed via a mouse click. Upon the conformation of the selection of the textual element the associated words may be at least temporarily presented in different style, colour or size for instance.

At Step S109, once the selection of the textual element has been confirmed, the word(s) corresponding to the textual element are extracted from the displayed text such that they may be input into any process, program or function which allows text to be input. For example, the words of the selected textual element may be extracted and automatically input into an Internet search engine or a search engine associated with a particular website i.e. a local search engine. In one example, the extracted worlds may be directly input into a search engine and the user automatically presented with the results of the search such that a textual element acts as pseudo hyperlink to a search results page.

Although in FIG. 1 two selection steps, S105 and S107 have been described, one section step may also be used and the indication of the selection may be presented at different times. For example, in embodiments where a mouse is being used as the input device, as the mouse cursor travels over the displayed text, the words of each textual element over which the cursor travels are indicated whilst the cursor is over the words of the textual element. Subsequently, to select a textual element, the user clicks on an indicated textual element and the words forming the selected textual element are briefly displayed in an alternative colour or style for example. Alternatively, the confirmation of the selection of a textual element may not be indicated to the user. Alternatively, Steps S105 and S107 may be combined such that a textual element is only indicated once it has been finally chosen to be extracted. For example, a textual element may not be indicated until it has been clicked upon and thus the associated words extracted from the displayed text. In yet another embodiment, all the textual elements may be indicated by being presented in a colour different to words of the text which do not form part of a textual element for instance. Subsequently, when a textual element is selected, the words of the selected textual element may be presented in another, different colour.

Although specific approaches to the selection and the indication of textual elements have been given above, these are for example only and in practice any suitable approach may be used. For example, different forms of indication and selection may be used depending on the user interface techniques available at the use display device whilst leaving the underlying functionality unchanged.

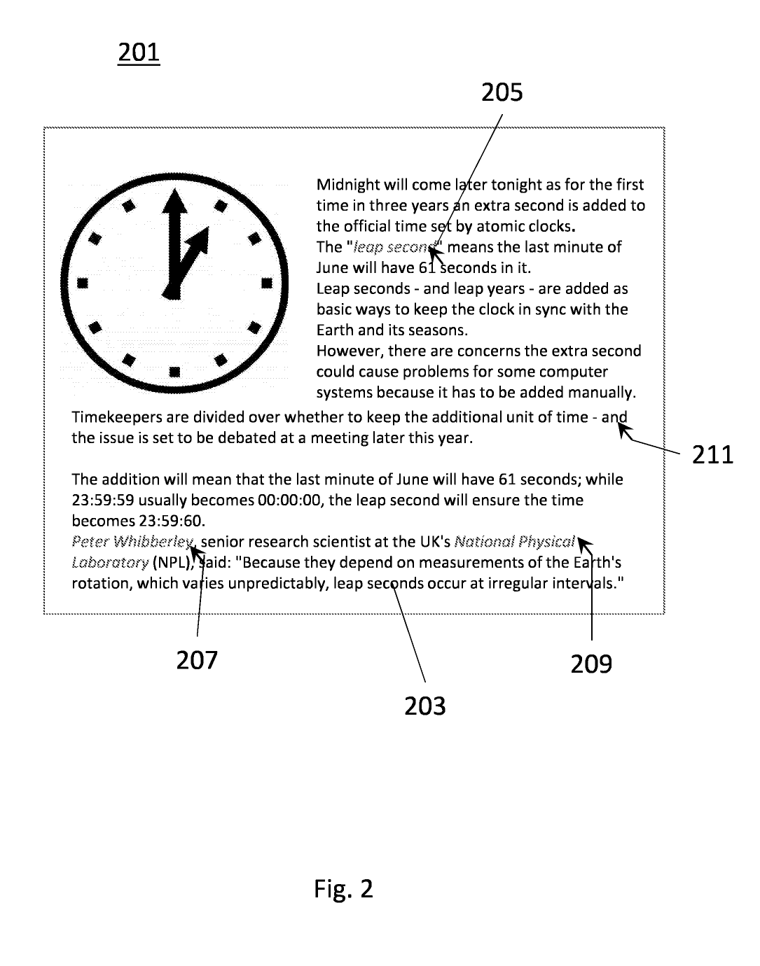

FIG. 2 provides an illustration of an example approach to indicating a textual element in displayed text when a mouse input interface is used. A webpage 201 is displayed on a user display device where the webpage includes text 203. As the cursor is moved across the text the various textual elements of the text are indicated to the user, where in FIG. 2 a textual element over which a cursor is placed is displayed in red and in italics. For example, when the cursor is positioned at point 205 it is positioned over the textual element “leap second”, the words of this textual element are indicated by being displayed in the colour red and italics. Likewise, when the cursor is positioned at positions 207 and 209, the words of textual element “Peter Whibberley” and “National Physics Laboratory” are indicated. However, as is explained below in more detail, not all words are eligible to form textual elements. Consequently, when the cursor is positioned at position 211, the word “and” is not highlighted because it is not eligible to form a textual element, or not by itself. Although the selection of textual elements has been described with respect to a mouse interface, a similar approach could be used for a touch interface. For example, textual elements may be indicated to a user as a drag touch is performed across displayed text but a textual element is selected and entered into a search engine for instance when an individual touch is made with respect to a textual element.

As one can see from FIGS. 1 and 2, embodiments of the present invention convert text from a variety of media sources into text which may be quickly and easily selected and searched by a user with little user interaction. Accordingly, the words of displayed text may act as links to search results based on the words, or as a means to input the words into another program. Embodiments may be particularly advantageous in touch screen applications where conventional approaches to selecting text and inputting it into other programs or search engines are slow and cumbersome and require users to manually determine the words which form textual elements they wish to search and then perform a multistep selection process to select the words. The functionality described with reference to FIGS. 1 and 2 may be referred to as Touch Word due to the ease with which words can be selected and searched using a touch screen interface.

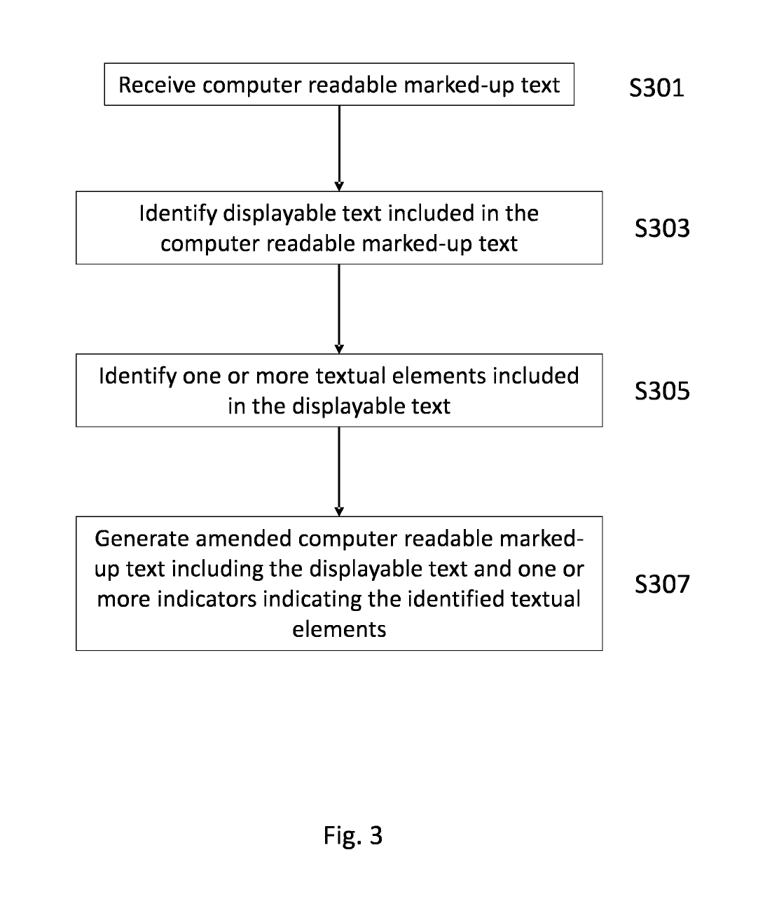

Embodiments of the present invention are described in further detail with respect to FIGS. 3 to 8, where the processing of text from first receipt up to extraction of textual elements and entry in to search engines is described.

In FIG. 3, text is first received at Step S301 at a computing device such as server or a user device, where the server may be a website host server or an Internet Service Provider (ISP) server, and the user device may be smart phone, laptop computer or a television for example. The text may be part of a webpage, a video stream, a live text feed or any other media which includes text. Preferably the text is in the form of marked-up text so that the displayable text included in the media can be quickly and easily identified without the need for optical character recognition (OCR) or similar process. However, in some embodiments OCR may be performed by the receiving device in order to identify text, where the identified text then converted into a form of marked-up text.

Throughout this description, marked-up text refers to text of any language which includes displayable text and possibly other information or tags which provide presentation or layout information for how to display the displayable text. Examples of marked-up text languages include HyperText Markup Language (HTML) and TeX, and embodiments of the present invention may operate with marked-up text in any of these languages. However, marked-up text may also refer to text included in closed captions or subtitles, or social networks feeds such as Twitter feeds for example. However, throughout this description, example embodiments of the present invention will be predominantly described with reference to marked-up text in HTML due to its ubiquity and comparatively settled implementation.

At Step S303, the displayable text of the received marked-up text is identified. For example where marked-up text is received in HTML, displayable text may be indicated by the tags such as <p> . . . </P> or <h1} . . . </h1> where the text between these tags is displayable text for a heading or standard paragraph for example. However, many other approaches to identifying displayable text may be used, where the mechanism used to identify displayed text is dependent on the form of the marked-up text.

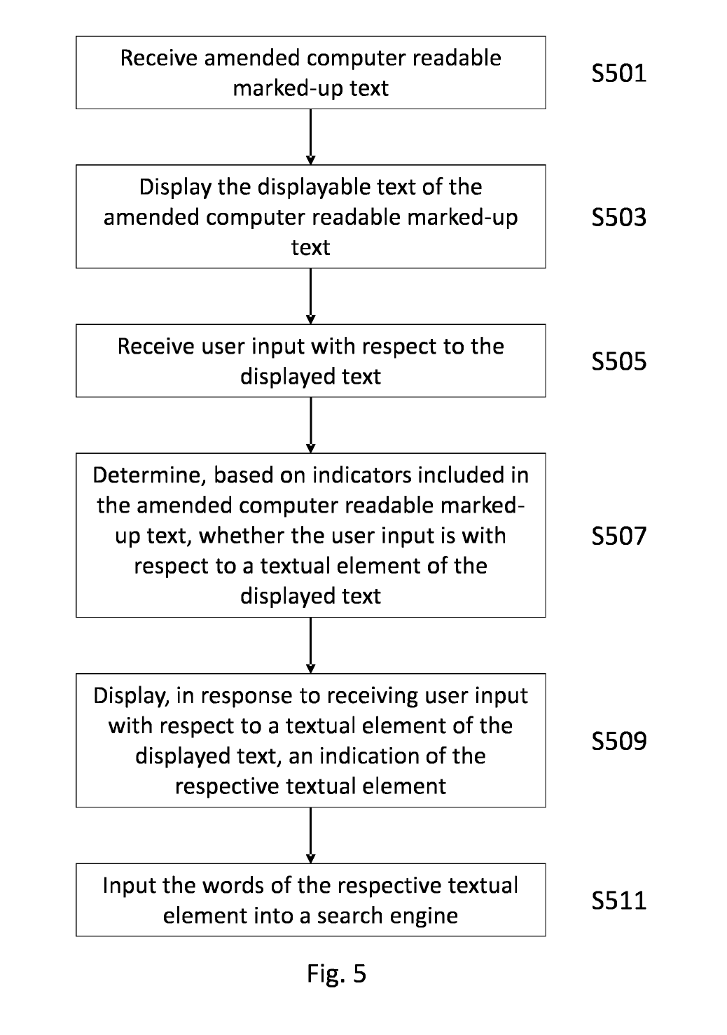

At Step S305, once the displayable text has been identified, one or more textual elements in the displayable text are then identified, where the textual elements are each formed of one or more words. For example, identified textual elements may include names, places, objects etc. The identification process of the textual elements is described in more detail with reference to FIG. 5.

At Step S307, amended computer readable marked-up text including the displayable text is generated, where the identified textual elements are indicated in the amended marked-up text. The identified textual elements may be indicated by any appropriate means but preferably they are indicated using tags or equivalent syntax which can be recognised by an appropriately configured computer program but does not affect the presentation of the marked-up text when processed by a conventional computer program. The generated marked-up text may be in the same language as the received marked-dup but this may not always be the case. For example, if marked-up text is received in HTML but the displayable text of the HTML file is to be displayed in a different format, it may be appropriate to generate the amended marked-up text in a different language, thus providing interoperability between different formats.

The steps of FIG. 3 may be further explained by referring to an example HTML file which acts as a source of marked-up text. Initially, an HTML file is received, where the HTML file may comprise marked-up text as shown below
<body><h1>Op-Ed Contributor:</h1><p>No Justice for Canada's First Peoples. The Truth and Reconciliation Commission has finished its work, and there is every indication that native people will be left, once again, with vague promises.</p><p>New York Times—World News</p></body>

The displayable text of HTML file is then identified by identifying tags such as <p> . . . </P> or <g1} . . . </h1>. Textual elements within the displayable text are then identified and indicated via the introduction of textual element tags, which in the case of HTML may take the form of <t-w> . . . </t-w> where the textual element tags are chosen so that they do not affect the presentation of the displayable text of conventional computer programs i.e. Internet browsers, but are recognised by appropriately configured programs i.e. Internet browser with an appropriate plugin so that the textual elements can be quickly identified. More specifically, the textual elements tags may be legal but unrecognised tags/syntax in the relevant marked-up text language so that the amended marked-up text may still be rendered as the original marked-up text would have been. Accordingly, though <t-w> . . . </t-w> are used as example textual element tags throughout this description, any legal but conventionally unrecognised tags may be used.

A shown below, the textual element tags are introduced around each of the textual elements to generate the amended marked-up text, where each in the present example textual elements are each enclosed by a <t-w> . . . </t-w> pair.

<body><h1><t-w>Op-Ed Contributor</t-w>: </h1><p><t-w>No
Justice</t-w> for <t-w>Canada's First Peoples</t-w>. <t-w>The
Truth</t-w> and <t-w>Reconciliation Commission</t-w> has
<t-w>finished</t-w> its work, and there is every <t-w>indication</t-w>
that <t-w>native</t-w> <t-w>people</t-w> will be left, once again, with
<t-w>vague</t-w> <t-w>promises</t-w>.</p><p><t-w>New York
Times</t-w> <t-w>- World</t-w> <t-w>News</t-w></p></body>

As one can see, the presentation and layout information has been preserved such that the displayable text will be displayed in the same layout as the displayable text of the original HTML text and thus the presence of the textual element tags will not be apparent to the user. However, to appropriately configured programs, each of the textual elements is recognisable and the functionality described above with reference to FIGS. 1 and 2 can be provided.

Although the layout information of the example HTML code has been preserved in the amended marked-up text set out above, the layout information may also be removed such that the amended marked-up text resembles the following

<t-w>Op-Ed Contributor</t-w>: <t-w>No Justice</t-w> for
<t-w>Canada's First Peoples</t-w>. <t-w>The Truth</t-w> and
<t-w>Reconciliation Commission</t-w> has <t-w>finished</t-w> its
work, and there is every <t-w>indication</t-w> that <t-w>native</t-w>
<t-w>people</t-w> will be left, once again, with <t-w>vague</t-w>
<t-w>promises</t-w>. <t-w>New York Times</t-w> <t-w>- World</t-w>
<t-w>News</t-w>

The amended marked-up text may be generated by amending the marked-up text in the file that it was originally received i.e. introduce textual element tags. Alternatively, a new file may be generated in which the textual element tags have been introduced into the marked-up text.

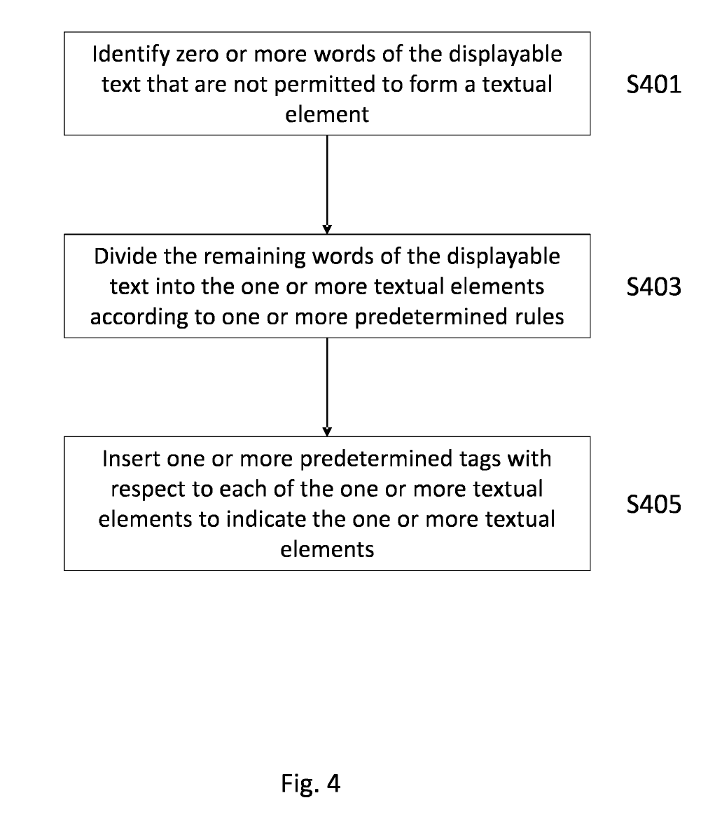

The process of identifying textual elements in displayable text is described with reference to FIG. 4, where, as set out above, may be performed at a user device, a server or any other entity in the transmission path of marked-up text which is to be displayed.

Textual elements are formed from one or more words and are used to easily extract words or sequences of words which a user may which to search or otherwise use.

Consequently, particular words or types of word that are unlikely to be of relevance or do not convey meaning should preferably be excluded from inclusion in textual elements. For example it may not be appropriate for conjunctions such as “and”, “for”, “nor”, “but”, “because”, “or”, “when”, or particular adjectives to form part of textual elements.

Consequently, an exclusion list is defined, where the exclusion list includes one or more predetermined words which are not permitted to form textual elements, either exclusively and/or as a component part. An example exclusion list for displayable text which is in English is given below
“,as,far,as,as,long,as,as,opposed,to,as,well,as,as,soon,as,according,to,ahead,of,apart,from, as,for,as,of,as,per,as,regards,aside,from,back,to,because,of,close,to,due,to,except,for,far, from,in,to,inside,of,instead,of,left,of,near,to,next,to,on,to,out,from,out,of,outside,of,owing, to,prior,to,pursuant,to,rather,than,regardless,of,right,of,subsequent,to,such,as,thanks,to,that, of,up,to,where,as,abaft,about,afore,after,against,along,amid,amidst,among,amongst,an, anenst,apropos,apud,as,aside,astride,at,athwart,atop,barring,before,but,by,concerning,despite, down,during,except,excluding,failing,following,for,forenenst,from,given,in,including,inside, into,lest,like,mid,midst,minus,modulo,near,next,notwithstanding,of,off,on,onto,opposite, out,outside,over,pace,past,per,plus,pro,qua,regarding,round,sans,save,since,than,through, throughout,till,times,to,toward,towards,unlike,until,unto,up,upon,versus,via,with,within,without, worth,about,above,across,after,again,against,all,almost,alone,along,already,also,although, always,among,an,and,another,any,anybody,anyone,anything,anywhere,are,area,areas, around,as,ask,asked,asking,asks,at,away,b,back,backed,backing,backs,be,became,because, become,becomes,been,before,began,behind,being,beings,best,better,between,big,both, but,by,came,can,cannot,case,cases,certain,certainly,clear,clearly,come,could,d,did,differ, different,differently,do,does,done,down,down,downed,downing,downs,during,e,each,early, either,end,ended,ending,ends,enough,even,evenly,ever,every,everybody,everyone,everything, everywhere,f,face,faces,fact,facts,far,felt,few,find,finds,first,for,four,from,full,fully,further, furthered,furthering,furthers,g,gave,general,generally,get,gets,give,given,gives,go,going, good,goods,got,great,greater,greatest,group,grouped,grouping,groups,had,has,have,having, he,her,here,herself,high,high,high,higher,highest,him,himself,his,how,however,i,if,important, in,interest,interested,interesting,interests,into,is,it,its,itself,j,just,k,keep,keeps,kind,knew, know,known,knows,l,large,largely,last,later,latest,least,less,let,lets,like,likely,long,longer,longest, made,make,making,man,many,may,me,member,members,men,might,more,most, mostly,mr,mrs,much,must,my,myself,n,necessary,need,needed,needing,needs,never,new, new,newer,newest,next,no,nobody,non,noone,not,nothing,now,nowhere,number,numbers, o,of,off,often,old,older,oldest,on,once,one,only,open,opened,opening,opens,or,order,ordered, ordering,orders,other,others,our,out,over,p,part,parted,parting,parts,per,perhaps,place, places,point,pointed,pointing,points,possible,present,presented,presenting,presents,problem, problems,put,puts,q,quite,r,rather,really,right,right,room,rooms,s,said,same,saw,say,says, second,seconds,see,seem,seemed,seeming,seems,sees,several,shall,she,should,show, showed,showing,shows,side,sides,since,small,smaller,smallest,so,some,somebody,someone, something,somewhere,still,still,such,sure,take,taken,than,that,the,their,them,then,there, therefore,these,they,thing,things,think,thinks,this,those,though,thought,thoughts,three,through, thus,to,today,together,too,took,toward,turn,turned,turning,turns,two,u,under,until,up,upon, us,use,used,uses,v,very,w,want,wanted,wanting,wants,was,way,ways,we,well,wells,went, were,what,when,where,whether,which,while,who,whole,whose,why,will,with,within,without, work,worked,working,works,would,x,y,year,years,yet,you,young,younger,youngest,your, yours,z,doesn't,you're,we're,they've,wouldn't,i'm,couldn't,there's,i've,-,--, getting,let's,cos,they're,i'll,‘i’im,don't,one's,yeah,wasn'it,shes's,isn't,he'll,‘i,”

As can be seen from the exclusion list, it is formed from words which do not convey or convey relatively little meaning in themselves or are relatively commonplace such that performing a search related to them would be unlikely to be of interest to a user. For instance, it is unlikely that a user would wish to search for “man” or “room”, thus these words are included in the exclusion list.

Referring to FIG. 4, in Step S401, once the displayable text has been identified, words which are excluded from textual elements are identified. This identification process may be performed by searching for words in the displayable text which are members of the exclusion list and then ignoring these words when identifying the textual elements.

At Step S403, once the zero or more words present on the exclusion list have been identified in the displayable text i.e. words which are not permitted to form textual element, the remaining words are divided into textual element according to one or more predetermined rules.

At Step S405 predetermined tags are then inserted into the marked-up text with respect to the identified textual elements in order to indicate the textual elements.

The one or more predetermined rules used to identify the textual elements may take a number of forms, for example, neighbouring capitalised words may indicate that the words represent a name of a place, person or institution. Therefore, in accordance with one rule neighbouring capitalised words may be defined as a textual element. For instance, with regard to FIG. 2, the words “National Physics Laboratory” may be defined as a textual element. According to another rule, non-capitalised words may be divided up individually. For example, individual words such as a “car” or “patent” may be individually defined as textual elements. In another example, words separated with linking terms may be defined as a textual element. For instance, the term “of” may be classified as a linking element or term, though possibly excluded as a textual element itself, so that words separated by “of” may be defined as a textual element , such that “King of Spain” may be defined as a textual element for example. In yet other examples, words which are commonly found together may also, or alternatively, be defined as a single textual element, such as “mobile phone” or “climate change” for instance.

Although the steps of FIG. 4 have been illustrated and described as being separate, they may also be combined or in some examples skipped. For example, it may not be necessary to have a discrete step of identifying one or more words which are not permitted to form textual elements. Instead at Step S403, only words not included in the exclusion list may be considered without explicitly identifying each of the words of the displayable text which is included in the exclusion list.

Since an exclusion list is used to identify the words which are not permitted to form textual element as opposed to an inclusion list which defines the words that are permitted to form textual elements, the exclusion list is not required to be as regularly updated since it is unlikely that a word will become so common place that it will no longer be of interest to a user in a short period of time. Conversely, because all words not on the exclusion list may form textual elements, new words which may have not previously existed will automatically be included in textual elements when they first appear in displayable text i.e. enter use. Therefore the process of identifying textual elements may not require adapting when new words enter a language. For example, words which have been newly defined or little used slang words will be automatically eligible to be included in textual elements since they will not be included in the exclusion list. Consequently, by use of an exclusion list, it is not necessary for Touch Word to recognise the word or the meaning of a word in order for textual element including the word to be identified.

Another advantage of identifying textual elements by use of an exclusion list is that it is relatively straightforward to apply the process of FIG. 4 to text in any language. In particular, it is simply required to form an appropriate exclusion list and, in some languages, alter a number of the predetermined rules for dividing up the displayable text into form textual element. For instance, if the purpose of capitalisation differs to that in the English language or capitalisation does not exist in a particular written language the predetermined rules may be required to be changed. An example exclusion list for displayed text in Spanish is given below
“, Ya que,ahora,ya que,como,mucho tiempo,ya que,como seopuso, para,como,bueno,como,como,muy pronto,ya que,de acuerdo,para,adelante,de,además,de,como,por,como,por, como,por,como,cuanto,además,de,la espalda,ya que,de,cerca,debido,excepto,para,lejos,de,en,hacia el interior,de cambio,de,dejó, de,cerca,para,a continuación,en,de,fuera,de,de,fuera,de,gracias,previo a,conforme,bastante,que,independientemente,de,derecha,de,con posterioridad,por ejemplo,ya que,gracias,que,de,encima de,donde,como,a popa,sobre,afore,después,en contra,a lo largo, en medio, en medio de,entre,entre,el,anenst,a propósito,apud,como,además,a caballo,en,de través, en lo alto,bloqueo de llamadas,antes,pero,por,en relación,a pesar de,abajo,durante,salvo,excluyendo,en su defecto,a raíz de,por,forenenst,del,dada,en,incluyendo,en el interior,en,no sea que,al igual que,en medio o medio,menos,en módulo,cerca,al lado,no obstante,de,apagado,encendido,en,frente,de,fuera,sobre,ritmo,más allá,por,además,favorable,qua,en relación con,redondo,sin,ahorrar,ya que,a través de,a lo largo,hasta que,los tiempos,hacia,hacia,a diferencia,hasta que,frente,a través de,con,dentro,fuera,vale la pena,alrededor,arriba,al otro lado,después,de nuevo,en contra,todos,casi,por sí sola,a lo largo,ya,también,aunque,siempre,entre,una,y,otro,cualquiera,nadie,nadie,nada,en cualquier lugar,son,el área, áreas,alrededor,como,pregunta,pregunta,pregunta,pregunta,distancia,b,de nuevo, el respaldo,el respaldo,la espalda,ser,se convirtió,pues,llegar a ser,se convierte,sido,antes,comenzaron,detrás,siendo,seres,mejor,mejor,medio,grande,los dos,pero,por,vino,puede,no puede,caso,casos,cierto,desde luego,claro,claro,ven,podrían,d,lo hizo,diferente,distinto,diferente,hacer, hace,hacer,abajo,abajo,detenido,el tragar,bajadas,durante,e,cada uno,ternprano,o bien,al final,terminó,termina,termina,lo suficiente,incluso,de manera uniforme,nunca,todos,todos,todos,todo en todas partes, f,cara,caras,hecho,hechos,lejos,fieltro,pocos,encontrar,se encuentra,en primer lugar,para,cuatro,de,Lleno,plenamente,aún más,favorecido,promover,promueve,g,dio,en general,por lo general,obtener,consigue,dar,dado,da,va,va,bueno,los bienes,conseguido,grande,mayor,grande,grupo,agrupadas,agrupación,grupos,tuvo,tiene,tiene, tiene,él,ella,aquí,ella misma,alto,alto,alto,más alto,más alto,él,él,su,cómo,sin embargo,yo,si,importantes,de,interés,interesados,interesante,intereses,en,es,es,es,en sí,j,sólo,k,mantener,sigue,amable,lo sabía,sabe,conoce,sabe,l,grande,en gran medida,el pasado,más tarde, muy tarde,por lo menos,menos,mucho,vamos,como,probablemente,mucho,más largo, más largo,hecho, hacer,haciendo,hombre,muchos,pueda,me,miembro,miembros,hombres,alma,más,más,en su mayoría,sr,señora,mucho,debe,a mi,me,n,necesario,necesidad,necesario,necesidad,necesidades, nunca,nuevo,nuevo,nuevo,el más nuevo,al lado,no,nadie,no,nadie,no,nada,ahora,en ninguna parte,número,números,o,de,fuera de,a menudo,viejo,más viejo,más viejo,en,una vez,uno,solo,abierto,abierto,apertura,abre o,orden,ordenado,pedidos,órdenes,otros,otros,nuestra,fuera,sobre,p,parte,se separaron,separando,partes,por,quizás,lugar,lugares, punto,señaló,apuntando,puntos,posibles,presentes,presentados,que presentan,regalos,problema,problemas,palabras,puts,q,bastante,r,más bien,de verdad,claro,claro,habitaciones,salas,s,dijo,el mismo,sierra,por ejemplo,dice,segundo,segundos,a ver,al parecer,parecía,al parecer,parece,ve,varios,deberá,ella,debe,demostración,mostró,mostrando,espectáculos,laterales, laterales,ya que,pequeño,más pequeño,el más pequeño,por lo que,algunos,alguien,alguien,algo,en algún lugar,aún,todavía,como,sí,tomar,tomar,de,que,los,las,ellos,entonces,hay,por lo tanto,estos,ellos,cosa,cosas,piensa,piensa,esta,estos,sin embargo,pensamiento,pensamientos,tres,a través de,por lo tanto,a día de hoy,junto,también,tomó,vuelta,vuelta,vuelta,vueltas,dos,u,bajo,hasta que,hasta, sobre,nosotros,el uso,utilizado,utiliza,v,muy,w,quiere,quiere,con ganas,deseos,fue,forma,formas,nosotros,así,pozos,fue,eran,qué,cuándo,dónde,si,lo que, mientras que,en conjunto,cuyo,¿por qué,voluntad,con,dentro,fuera,trabajo,trabajando,trabajo,obras,lo haría,x,y,años,años,sin embargo,usted,joven,más joven,más joven,su,el suyo,z,no,usted es,que estamos,que hemos,¿no,soy,no podía,no hay,tengo,-,-,el conseguir,vamos,cos,que ‘re,voy,‘i’im,no,de uno,sí,wasn'it,de los shes,no es,él ‘i,”

As well as written language based upon alphabetic scripts, the identification of textual elements will operate for any script for which an exclusion list has been formed. For example, the steps of FIG. 4 are equally applicable to written languages based upon Logographic, Syllabic, Abjad and Abugida scripts.

FIG. 5 illustrates in more detail the steps of displaying and selecting textual elements which were described with reference to FIGS. 1 and 2.

In Step S501 amended marked-up text generated in accordance with the methods of FIGS. 3 and 4 is received at a user display device. Although the marked-up text may take any form, throughout FIG. 5 marked-up text will assumed to be HTML code which has been received as part of a HTML file.

In Step S503, the displayable text of the amended marked-up text is displayed on the user display device via the use of an Internet browser for example.

As previously explained, the textual element tags introduced into the amended marked-up text are preferably legal but unrecognised by conventional computer programs such as Internet browsers. Therefore the content of HTML file will be presented normally by a conventional Internet browser even though textual elements tags are present in the file.

However, in accordance with embodiments of the present invention, if the Internet browser is appropriately configured or if an appropriate executable code such as JavaScript program for example is running at the user device, the functionality described with reference to FIGS. 1 and 2 can be provided.

More specifically, when the amended marked-up text is being rendered by an Internet browser for instance, the Internet browser is configured to recognise the indications of the textual elements included in the amended marked-up text and monitor for user interaction with displayed textual elements. Consequently, when user input is received with respect to the displayed text at Step S505, it is then determined at Step S507 whether the user input is with respect to a textual element. This may be performed for example by determining the text which has been interacted with and then comparing this text to the indicated textual elements of the amended marked-up text. As previously explained, the user input may take the form of a mouse click, a mouse, roll-over, a touch input or a combination of these inputs for example.

At Step S509, when it is determined that the user input is with respect to a textual element, an indication of the respective textual element is provided to the user as described with reference to FIG. 2. For example, the indication may be provided to the user when they roll-over or hover the mouse cursor over a textual element or when they confirm they wish to select a textual element by clicking on it.

At Step S511, the words of the selected textual element are then extracted from the amended marked-up text and input into any chosen function, such as an Internet search engine, local search engine, a website specific search engine, an electronic form or a word processing program for example.

As set out above, Steps S505 to S511 will be performed by an appropriately configured program such as an Internet browser, where the functionality may be provided in a number of different ways. For example, as well as introducing textual element tags into the amended marked-up text, if the marked-up text is in HTML, JavaScript which causes the browser to perform the functionality of Steps S505 to S511 may also be included in the amended HTML file. Consequently, when the amended HTML file is received, a browser will be configured to perform Steps S505 to S511 by virtue of executing the JavaScript. Alternatively, a specific software plugin may be required for a browser such that the browser is configured to recognise the textual element tags in an amended HTML file and subsequently perform Steps S505 to S511. In another example, the textual element indicators maybe introduced to the HTML standard such that all browsers compliant with the appropriate version of HTML will be configured to perform the steps of S505 to S511. In such an example, the identification and indication of textual elements may be performed by the creator of a webpage such that the source HTML code of a website includes the textual element tags.

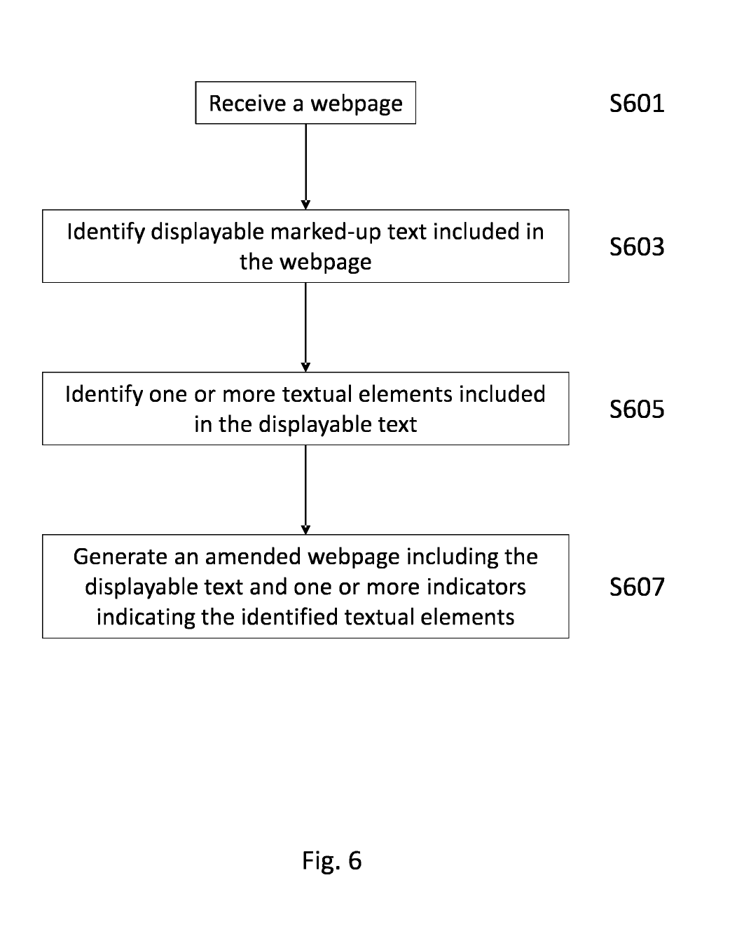

FIG. 6 illustrates the steps which may be performed by a device which generates an amended HTML file corresponding to a webpage.

At Step S601, the webpage i.e. the HTML file is received.

At Step S603, the displayable text included in the marked-up text of the HTML file of the webpage is identified.

At Step S605, one or more textual elements included in the displayed text are identified in accordance with the process described with reference to FIG. 4.

At Step S607, the identified textual elements are then indicated in the marked-up text via the introduction of textual element tags into the marked-up text in order to generate amended marked-up text, which in the current example may be an amended HTML file. If generated at a sever, the amended HTML file may then be sent to a user device for rendering by an Internet browsers, or if generated at a user device, the amended HTML file may be passed to an Internet browser or passed within an Internet browser for rending and subsequent interaction with by a user.

Although described with reference to a webpage, the process of FIG. 6 may be performed on any marked-up text file of code. For example, if the marked-up text were to be closed captions of a video stream, textual element tags may be inserted into the closed captions such that the video stream itself includes textual element tags. Subsequently, a user may then select textual elements of the closed captions.

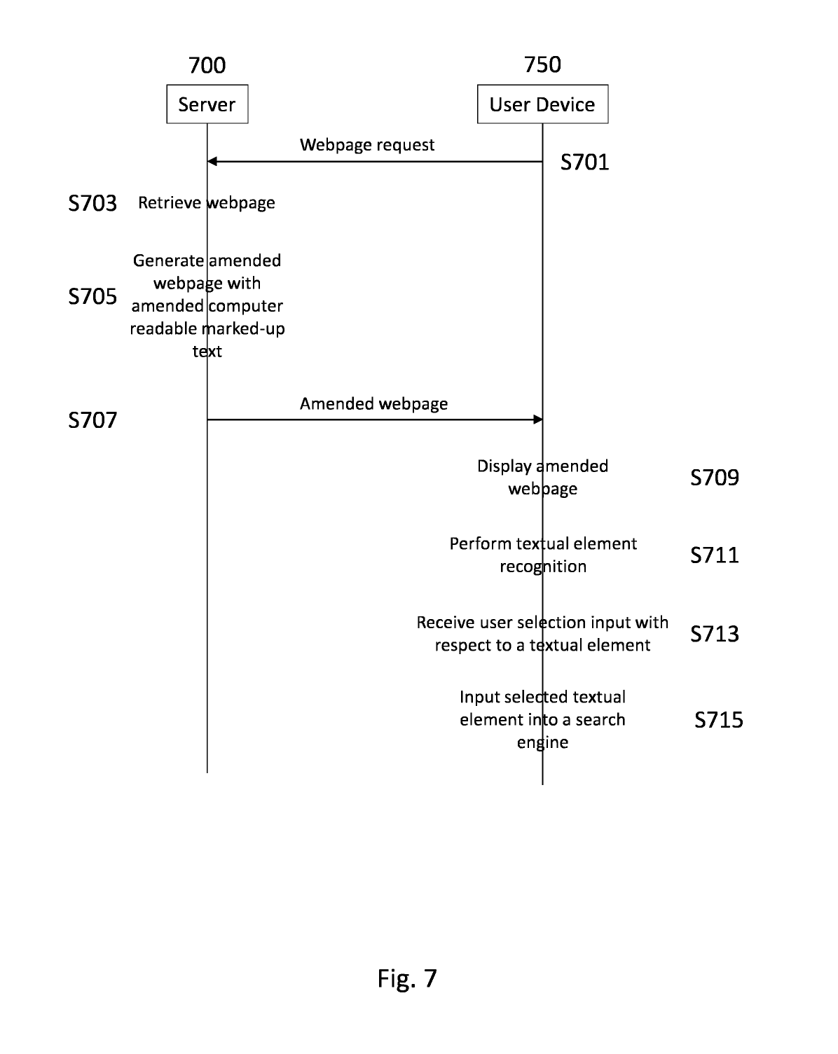

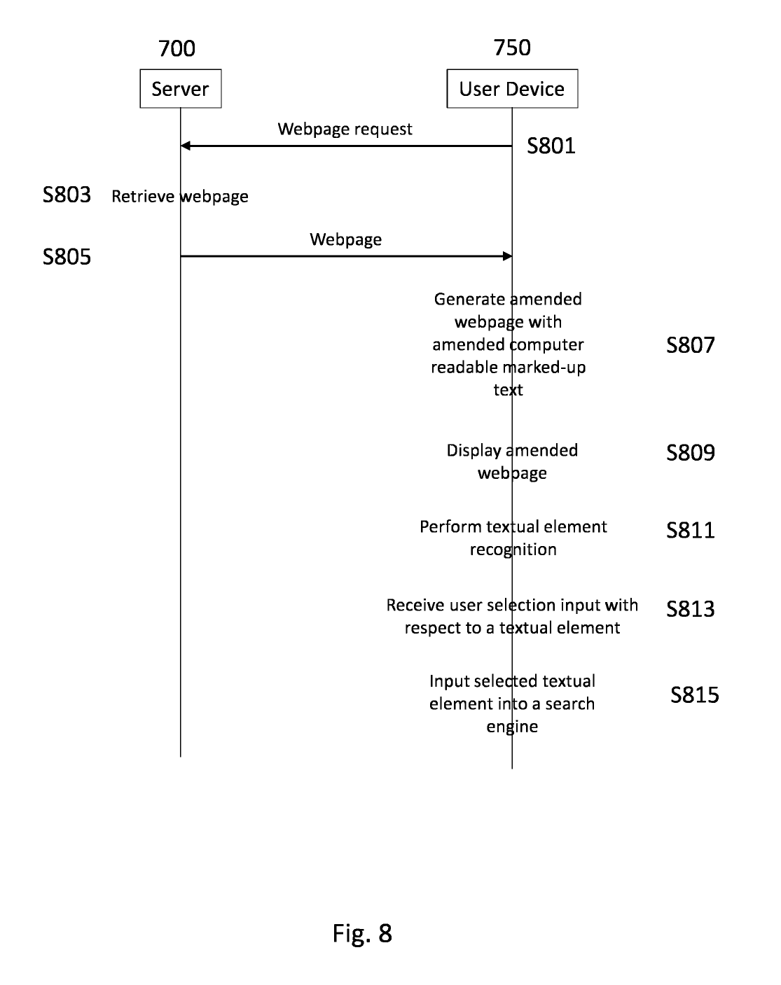

FIGS. 7 and 8 provide illustrations of simplified example communications flows that may take place between a server 700 and a user device 750 in embodiments of the present invention where a user is browsing the Internet such that the marked-up text is in the form of an HTML file corresponding to a website.

FIG. 7 illustrates an embodiment where a server performs the generation of the amended marked-up text and thus the amended HTML file.

At Step S701, a webpage request is made from the user device 750 to the server 700, where the server may be an Internet service provider (ISP) associated with the user device, a server hosting the website or an intermediate server.

At Step S703, upon reception of the webpage request from the user device the server retrieves the HTML file associated with the webpage, where the webpage may be stored at the server or at a different server.

At Step S705, the server generates an amended HTML file from the retrieved HTML file where textual elements of the marked-up text within the HTML file have been identified and indicated via the introduced of textual element tag. In some embodiments, additional code such as JavaScript may also be inserted into the HTML file to enable computer programs such as Internet browsers at the user device to perform the processing described with reference to FIG. 5.

At Step S707, the amended HTML file is sent to the user device and the user device, or more precisely a program at the user device, performs steps S709 to S715 where these steps, though simplified, are equivalent to the steps of FIG. 5.

At Step S709, the user device displays the webpage as set out by the received amended HTML file.

At Step S711, the user device recognises the textual elements by identifying the textual element indicators that were introduced into the amended HTML file.

At Step S713, the user device receives an input to and/or a selection of a textual element and indicates to the user the textual element with which the input was with respect to.

At Step S715, the word(s) of the selected textual element are extracted and input to a search engine and a search then performed.

Although in FIG. 7 the generation of the amended marked-up text is performed in response to the user webpage request, the amended marked-up text corresponding to webpages may have been generated at an earlier point in time prior to receiving the user request and stored in memory either at the server or in external storage for retrieval at a later point in time. Furthermore, the steps of S709 and S711 may be performed together or in a different order.

FIG. 8 illustrates an embodiment where the user device performs the generation of the amended marked-up text and thus the amended HTML file. The steps of FIG. 8 are similar to those of FIG. 7, where Steps S801, S803, and S809 to S815 correspond to Steps S701, S702 and S709 to S715, respectively but the original HTML file is sent to the user device at Step S805 and the generation of the amended HTML file is performed by the user device such that Step S807 is performed at the user device.

The functionality of Steps S807 to S815 may be provided by a plugin to an Internet browser, where upon reception of an HTML file the plugin generates an amended HTML file which is then passed to the browser as per a conventional HTML file. In this manner the plugin acts as an intermediate layer between the receipt of an HTML file and the display of the HTML file. Such a plugin may provide the textual element selection functionality directly by running in the background when an amended HTML filed is displayed or may introduce JavaScript or code with equivalent functionality into the amended HTML file such that the textual element selection functionality is automatically provided when the amended HTML file is displayed.

As a result of generating the amended HTML file at the user device, no reconfiguration of website host servers or ISP servers is required, thus allowing textual element selection and thus Touch Word to be performed on any received HTML file not just those selected by a server. Furthermore, since an amended HTML file may be generated for each webpage that is requested, if a textual element from a webpage is selected and results in the display of a new webpage, the new webpage will also have been processed according to the embodiments of the present invention technique and thus textual elements of the new webpage will also be able to be selected Consequently, a circular process where the text of all website becomes quickly and easily searchable is formed. A similar result may also be achieved if all HTML files destined for the user device pass through an ISP server and the ISP server generates an amended HTML files for each requested webpage. Since the method illustrated in FIG. 8 may be applied to each received file, the method may be seen to be an additional layer of processing which a received file passes through and introduces the textual element selection functionality.

Preferably, although not exclusively, embodiments of the present invention operate on the displayable text of marked-up text such as HTML file. Therefore the complexity of the textual element identification and the generation of amended marked-up text is relatively low. Consequently, the functionality of the present invention may be introduced into a system with little effect on the speed of the system. For example, if the generation of the amended marked-up text is performed at a user device, there may be little effect on the speed at which webpage is rendered from an HTML file.

As mentioned above, the technique of the present invention may operate upon any form of marked-up text or publishable document, and, in some examples, text which has been recognised via OCR. Consequently, it is also possible to apply the present technique to video streams which include marked-up text in the form of subtitles or closed captions for instance. For example, if a television news channel or video streaming service were to include subtitles in their video stream, in accordance with the present invention the textual elements of the subtitles would be searchable by simply selecting them as they are displayed on the screen. For instance, if a news article on “Cuba” is being displayed as a video stream to a laptop user, the user may click upon “Cuba” in the subtitles and an Internet search on “Cuba” may be automatically performed and displayed to the user or presented in another window or tab. Alternatively, a search based upon “Cuba” may be performed on the content of subtitles of other video streams or news feeds, thus presenting the user with one or more related video streams or news feeds.

As stated above, embodiments of the present invention may also operate upon a publishable document. For example, a word processing document effectively contains marked-up text and therefore, if the method of the present invention is appropriately configured to identify the displayable text and insert appropriate indicators of textual elements, and the word processing program is appropriately configured to recognise the textual element indicators, the functionality described with reference to HTML and webpages may be provided for word processing documents.

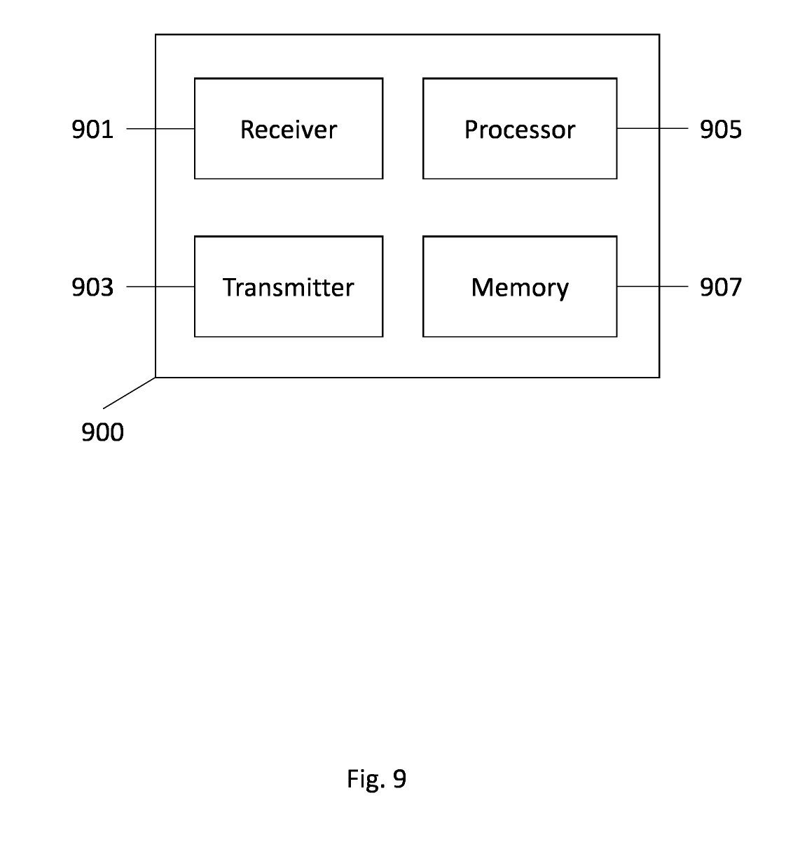

FIG. 9 provides a schematic illustration of a server 900 operable to perform one or more of the previously described methods and interactions. The server may comprise a receiver 901, a transmitter 903, a processor 905 and a memory 907. The receiver 901 is configured to receive marked-up text, where the marked-up text may have been received from an external storage device or the memory 907. Once the marked-up text has been received, the processor 905 is configured to perform the one or more of the steps of FIGS. 3, 4, 6 and 7 to generate the amended marked-up text. Upon completion of the generation of the amended marked-up text, the transmitter 903 may then transmit the amended marked-up text to a client device such as a user device.

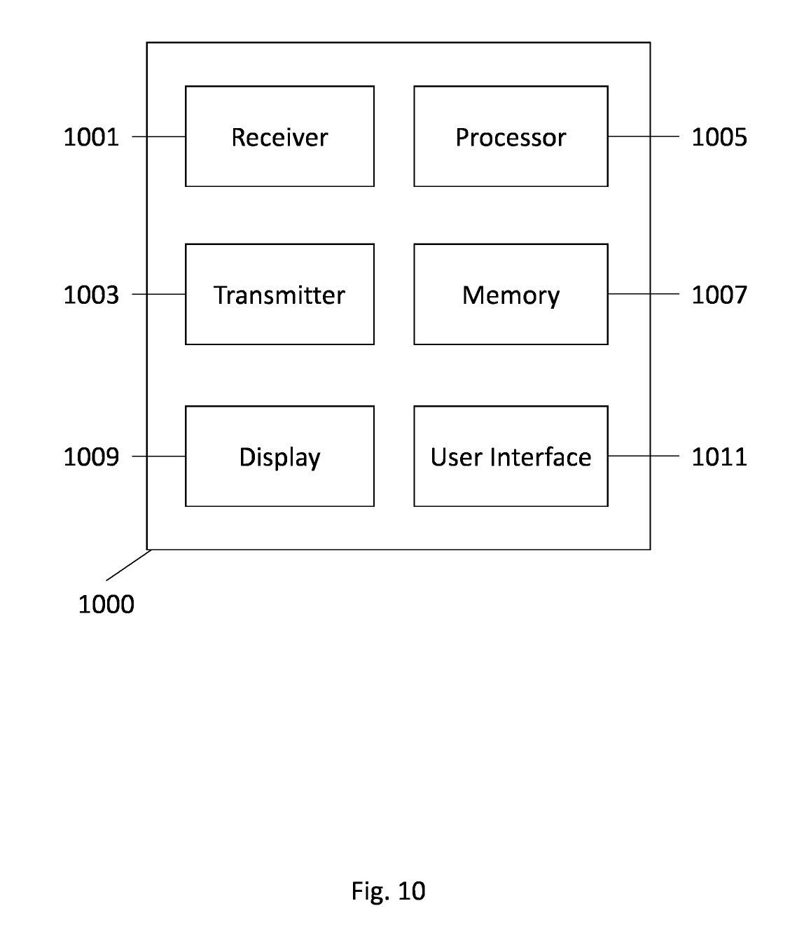

FIG. 10 provides a schematic illustration of a user device 1000 operable to perform one or more of the previously described methods and interactions. The user device may comprise a receiver 1001, a transmitter 1003, a processor 1005, a memory 1007, a display 1009 and a user interface 1011.

In a first example where the user device does not generate the amended marked-up text, the receiver 1001 is configured to initially receive the amended marked-up text or file from a server, where the receipt of the amended marked-up text may be in response to request transmitted by the transmitter 1003 to the server. Once received, the amended marked-up text may be stored in the memory 1007, and the processor 1005 controls the display to display displayable text of the amended marked-up text. Once displayed, the processor is configured to detect a user input received through the user interface 1011 to the displayed text, where the user interface may be a touchscreen or a mouse for example. Subsequent to the detection the user input, the processor determines, based on the indicators in the amended marked-up text, whether the received user input is with respect to a textual element of the displayed text, and, in response to receiving user input with respect to a textual element of the displayed text, controls the display to display an indication of the respective textual element. The processor may then also extract the word(s) of the respective textual element and input them into a search engine. As set out above, the steps of determining whether a textual element has been selected, displaying an indication of the selected textual element and insertion of the words of the selected textual element into a search engine may be performed as a result of client-side executable code contained within the amended marked-up text which is executed by the processor. However, alternatively, instead of client-side executable code such as a JavaScript, the processor may execute a program which is stored in the memory to perform equivalent functionality. For example, such an executable program may be a plugin or extension to a browser which is used to render the amended marked-up text.

In a second example, the user device may be configured to perform the method illustrated in FIG. 8 where the user device generates the amended marked-up text. The functional elements of the user device are configured to perform similar functionality as described above, but the receiver 1001 instead receives the un-amended marked-up text from a server and it is from this that the processor then generates the amended marked-up text according to the methods of FIGS. 3 and 4. To perform the generation of the amended marked-up text, the processor may for example execute software which forms part of an Internet browser. Alternatively the processor may execute software which passes the amended marked-up text to a range of different programs for rendering, such as a word processor for instance.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers or characteristics described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

The various embodiments of the present invention may also be implemented via computer executable instructions stored on a computer readable storage medium, such that when executed cause a computer to operate in accordance with any other the aforementioned embodiments.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method for generating computer readable marked-up text, the method comprising:
receiving computer readable marked-up text;
identifying displayable text included in the computer readable marked-up text;
identifying one or more textual elements included in the displayable text; and
generating amended computer readable marked-up text including the displayable text and one or more indicators indicating the identified textual elements.

2. The method of claim 1, wherein the displayable text comprises one or more words and a textual element is formed from one or more words, and one or more predetermined words are not permitted to form a textual element, and the identifying one or more textual elements includes
dividing the words of the displayable text that are not one of the one or more predetermined words into the one or more textual elements according to one or more predetermined rules.

3. The method of claim 1 or 2, wherein the method further comprises:
displaying the displayable text of the amended computer readable marked-up text;
receiving user input with respect to the displayed text;
determining, based on the indicators, whether the user input is with respect to a textual element of the displayed text; and
displaying, in response to receiving user input with respect to a textual element of the displayed text, an indication of the respective textual element.

4. The method of any preceding claim, wherein generating the amended computer readable marked-up text includes inserting the indicators into the received computer readable marked-up text.

5. The method of any preceding claim, wherein the indicators include one or more predetermined tags

6. The method of claim 5, wherein generating the amended computer readable marked-up text includes enclosing each identified textual element with a pair of the predetermined tags.

7. The method of claim 3, wherein the amended computer readable marked-up text includes display layout information and the displaying the amended computer readable marked-up text includes displaying the displayable text in accordance with the display layout information.

8. The method of any preceding claim, wherein the computer readable marked-up text is in the HyperText Markup Language, HTML.

9. The method of any preceding claim, wherein the amended computer readable marked-up text is in the HTML.

10. The method of claim 8 or 9, wherein the tags are non-standard HTML tags.

11. The method of any preceding claim, wherein the marked-up text is included in closed-caption information.

12. The method of claim 3, wherein, in response to receiving user input with respect to a textual element of the displayed text, inputting the respective textual element into a search engine.

13. The method of claim 12, wherein the marked-up text is included in an HTML file and the amended marked-up text is included in an amended HTML file, and one or more of the determining whether the user input is with respect to a textual element of the displayed text, the displaying an indication of the respective textual element, and the inputting the respective element into a search engine are performed by client-side executable code included in the amended HTML file.

14. The method of claim 13, wherein the client-side executable code is JavaScript.

15. A user device for displaying displayable text of marked-up text, the user device comprising
a receiver configured to receive marked-up text; and
a processor configured to:
identify displayable text included in received computer readable marked-up text;
identify one or more textual elements included in the displayable text; and
generate amended computer readable marked-up text including the displayable text and one or more indicators indicating the identified textual elements.

16. The user device of claim 15, wherein the displayable text comprises one or more words and a textual element is formed from one or more words, and one or more predetermined words are not permitted to form a textual element, and wherein the identifying one or more textual elements includes
dividing the words of the displayable text that are not one of the one or more predetermined words into the one or more textual elements according to one or more predetermined rules.

17. The user device of claim 15 or 16, wherein the user device further comprises:
a display configured to display the displayable text of the amended computer readable marked-up text; and
a user input interface configured to receive user input with respect to the displayed text; and wherein the processor is configured to:
control the display to display the displayable text;
detect a user input received through the user interface, determine, based on the indicators, whether the received user input is with respect to a textual element of the displayed text; and, in response to receiving user input with respect to a textual element of the displayed text,
control the display to display an indication of the respective textual element, and
extract the words of the respective textual element.

18. The user device of claim 17, wherein, the processor is configured, in response to receiving user input with respect to a textual element of the displayed text, to input the words of the respective textual element into a search engine.

19. A server for providing marked-up text to a user device, the server comprising
a receiver configured to receive marked-up text;
a processor configured to:
identify displayable text included in received computer readable marked-up text;
identify one or more textual elements included in the displayable text; and
generate amended computer readable marked-up text including the displayable text and one or more indicators indicating the identified textual elements; and
a transmitter configured to transmit the amended computer readable marked-up text to the user device.

20. A computer readable recording medium having stored thereon computer executable instructions which when executed by a computer cause the computer to perform the method of any of claims 1 to 14.

21. A method substantially as hereinbefore described with reference to any of FIGS. 1 and 3 to 8.

22. A server substantially as hereinbefore described with reference to FIG. 9.

23. A server substantially as hereinbefore described with reference to FIG. 10.
